(19) United States
(12) Patent Application Publication
(10) Pub. No.: US 2004/0197731 A1
(43) Pub. Date: Oct. 7, 2004

(54) Dental abrasive system using helium gas

(76) Inventor: Keith Daniel Swan, Los Angeles, CA (US)

Correspondence Address: SHELDON & MAK, INC, 225 SOUTH LAKE AVENUE, 9TH FLOOR, PASADENA, CA, 91101, US

(21) Appl. No.: 10/402,753

(22) Filed: Mar. 27, 2003

(51) Int. Cl. A61C 3/02

(52) U.S. Cl. 433/88

(57) ABSTRACT

The present invention provides a gas dental abrasive system using pressurized helium gas. The system includes an apparatus for abrading teeth using an abradant having a pressurized helium gas source and a control for regulating pressurized helium gas to form a carrier gas containing helium gas for carrying the abradant to teeth. The system also includes a dual gas apparatus with a pressurized helium gas source; a source of pressurized non-helium gas; and a control capable of selectively mixing the pressurized helium and the pressurized non-helium gas to form a carrier gas for carrying the abradant to teeth, wherein the carrier gas can contain from 0-100% helium gas. The system further includes a method of abrading teeth with the steps of providing an abradant; and delivering the abradant to teeth with pressurized helium carrier gas.

### BACKGROUND

The present invention relates generally to dental abrasive systems, and more particularly to dental abrasive systems using compressed or pressurized gas for dental procedures such as cutting a tooth, amalgam, composites, other dental tooth filling materials; removing stains on teeth; and polishing teeth.

Known dental air abrasive systems typically comprise an elongated tube having a nozzle at one end and having its other end coupled through a valve to a source of compressed or pressurized gas, typically compressed air. Additionally, a powder reservoir having a mixing chamber, which can be connected to a vibrator, holds an abradant, such as aluminum oxide. The abradant from the mixing chamber is fed into a passageway between the compressed air and the nozzle. Thus, with the valve open, the compressed air creates a carrier gas for carrying the abradant that was fed into the passageway. The carrier gas is expelled outwardly through the end of the nozzle, and directed so that it impinges upon the tooth for the dental procedure, which is often cutting or drilling the tooth. Examples of known systems that employ pressurized gas or air are described in U.S. Pat. No. 2,696,049 to Black and in U.S. Pat. No.5,334,019 to Goldsmith et al., that are incorporated in their entirety by reference, herein.

As used herein, “known dental air abrasive systems” or “dental air abrasive systems” mean dental systems that use compressed air, carbon dioxide, or nitrogen as the pressurized propellent that mixes with the abradant to form the carrier gas. Compressed air is readily available in a dental setting, and is usually the pressurized gas of choice for these systems.

Dental air abrasive systems have been used as an alternative to mechanical drills for certain dental procedures. The direct contact of the mechanical drill with the tooth causes vibrations and heat generally creating a considerable degree of pain for an un-anesthetized patient. To counteract these negative effects, there is generally a greater reliance on local anesthesia for deadening of a patient's responsiveness or sensitivity to the pain. This deadening can occur to such a degree to eliminate the safeguard inherent in a patient's normal reactions to the drilling operation. In contrast, dental air abrasive systems generally decrease the reliance on local anesthesia as compared to the mechanical drill, and are considered less painful than the mechanical drill.

While dental air abrasive systems have been used as an alternative to the mechanical drill, dental air abrasive systems suffer from several problems. One problem is that known dental air abrasive systems cannot drill as fast as the mechanical drill. A dental procedure can take less time using the mechanical drill. Another problem is these dental air abrasive systems cannot efficiently drill through soft leathery decay on the tooth, whereas a mechanical drill effectively accomplishes this task. Another problem with known dental air abrasive systems is that pressures of 80 PSI and usually much higher are needed to cut the tooth. A patient's discomfort typically increases with the increase of carrier gas pressure necessary to accomplish the dental procedure. Likewise, the lower pressure that can effectively be used in the dental procedure, the greater likelihood of reduced patient discomfort.

Accordingly, there is a need for a dental abrasive system using pressurized gas that: drills as fast as mechanical drills; cuts efficiently through soft leathery decay; and can work efficiently below 80 PSI for most dental procedures, including cutting teeth.

The above description provides a summary of information relevant to the present invention and is not a concession that any of the information provided or publications referenced herein is prior art to the presently claimed invention.

### SUMMARY

The present invention is directed to a dental abrasive system using pressurized helium gas that satisfies these needs. In particular, the dental abrasive system of the present invention can drill as fast as a mechanical drill. The dental abrasive system of the present invention, also similar to the mechanical drill, can cut efficiently through soft leathery decay. The dental abrasive system of the present invention can cut tooth below 80 PSI, and effectively reduce or minimize patient discomfort with lower pressures. The present invention can minimize the time necessary to perform certain dental procedures, and also minimize discomfort to the patient without resorting to mechanical drills.

The system according to the present invention include: apparatus for abrading teeth using an abradant, and methods of abrading teeth. An apparatus for abrading teeth using an abradant according to the invention has a pressurized helium gas source; and a control for regulating pressurized helium gas to form a carrier gas containing helium gas for carrying the abradant to teeth. Embodiments of this include wherein the carrier gas formed has a pressure of below 80 PSI for carrying the abradant to the teeth; and including wherein the carrier gas formed has a pressure of about 60 PSI or below, about 50 PSI or below, about 40 PSI or below, about 30 PSI or below, and about 25 PSI or below, for carrying the abradant to the teeth.

Another apparatus for abrading teeth with an abradant according to the invention has a pressurized helium gas source; a source of pressurized non-helium gas; and a control capable of selectively mixing the pressurized helium and the pressurized non-helium gas to form a carrier gas for carrying the abradant to teeth, wherein the carrier gas can contain from 0-100% helium gas.

Another apparatus for abrading teeth with an abradant according to the invention has a pressurized helium gas source; a source of pressurized non-helium gas; a conduit for delivering the pressurized non-helium gas to a pneumatic valve; and a control for regulating pressurized helium gas to form a carrier gas containing helium gas for carrying the abradant to teeth, and for regulating the delivery of pressurized non-helium gas to the pneumatic valve. Embodiments of this include wherein the carrier gas formed has a pressure of below 80 PSI for carrying the abradant to the teeth; and including wherein the carrier gas formed has a pressure of about 60 PSI or below, about 50 PSI or below, about 40 PSI or below, about 30 PSI or below, and about 25 PSI or below, for carrying the abradant to the teeth.

Another apparatus for abrading teeth with an abradant has a pressurized helium gas source; a source of pressurized non-helium gas; and a control for mixing pressurized helium gas and pressurized non-helium gas to form a carrier gas containing both gases for carrying the abradant to teeth.

Embodiments of apparatus described above according to the invention can further include: where the pressurized non-helium gas is selected from the group consisting of air, carbon dioxide, and nitrogen; has a pneumatic valve and a conduit for delivering pressurized non-helium gas to the pneumatic valve, and wherein the control is further capable of operating the pneumatic valve; and has a vibrator directly attached to the pneumatic valve.

A method of abrading teeth has the steps of providing an abradant; and delivering the abradant to teeth with pressurized helium carrier gas. Another method of abrading teeth of the invention has the steps of providing an abradant; and delivering the abradant to teeth with pressurized helium carrier gas below 80 PSI. Another method of abrading teeth has the steps of providing an abradant; and delivering the abradant with a pressurized carrier gas comprising at least 1% by volume helium and at least 1 % by volume of a non-helium gas.

### DRAWINGS

These features, aspects and advantages of the present invention will become better understood with regard to the following description, appended claims and accompanying figures where:

FIG. 1 is a schematic view illustrating a first preferred embodiment of the present invention.

FIG. 2 is a schematic view illustrating a second preferred embodiment of the present invention.

### DESCRIPTION

The following discussion describes embodiments of the invention and several variations of these embodiments. This discussion should not be construed, however, as limiting the invention to these particular embodiments. Practitioners skilled in the art will recognize numerous other embodiments as well.

As used herein, the term “tooth” or “teeth” means not only the natural composition of the tooth, but also includes amalgam, composites, other dental tooth filling materials and includes stains present on the tooth or teeth.

Referring to the figures, a representative dental abrasive system embodying features of the invention comprises an apparatus 10 with a pressurized helium gas source 12, a source of pressurized non-helium gas 14, and a control 16. The system also includes: a source of an abradant 18, a main gas regulator 20, a powder reservoir 22 having a mixing chamber 23, a vibrator 24, a pneumatic valve 26 directly attached to the vibrator 24, a flexible output tube 28 connected to the valve 26, and a nozzle 30 attached at one end of the output tube 28. Not shown in the application is an apparatus according to the present invention using pressurized helium gas source 12 (without a source of pressurized non-helium gas 14) and a control 16.

The abradant 18 is fed into a powder reservoir 22 having a mixing chamber 23. An abradant commonly used in dental air abrasion systems is aluminum oxide. Aluminum oxide was the abradant source used in the inventor's experiment described in the example. Bicarbonate of soda, and silicon carbide can be used as abradants. However, other abradants can be employed in the invention, and the invention is limited to the use of these particular abradants.

The control 16 regulates the mixture of pressurized helium and the pressurized non-helium gas to form a carrier gas for carrying the abradant 18 to the tooth or teeth. One way the control 16 can regulate the gas going into the mixing chamber 23 is through the main gas regulator 20. The control 16 can regulate the carrier gas to contain from 0-100% helium gas. The construction of a control 16 that regulates gas going into the mixing chamber 22, and/or the mixture of two gases, and/or for operating or regulating the delivery of pressurized non-helium gas to the pneumatic valve 26 is well within the knowledge of a person of ordinary skill in the art. For example, the Crystal Mark DV-1 Air Abrasion Unit upgrade model (manufactured and sold by Crystal Mark, 613 Justin Avenue, Glendale, Calif. 91201) uses a toggle switch as a control 16 for switching between helium gas and non-helium gas, typically compressed air, that flows into the main gas regulator 20. Any control that is able to regulate the mixture of gas and/or switch the gas from one to the other can be used in the present invention.

Almost any source of pressurized non-helium gas can be used with the present invention. However, most dental offices throughout the United States that use a dental abrasive air systems are equipped with a dedicated compressor capable of generating compressed air having a pressure between about 80 and 160 PSI. Pressurized carbon dioxide and nitrogen have also been used in dental abrasive air systems, and can be used as the non-helium gas in combination with the helium gas source of the present invention. The pressurized non-helium gas should be inert and non-toxic. However, other non-helium gases under pressure can be employed in the invention in its broader aspects is not to be limited to the use of these particular non-helium gases.

The abradant 18 from the mixing chamber 23 mixes with the carrier gas. The vibrator 24 helps mixes the abradant 18 with the pressurized gas forming the carrier gas carrying the abradant 32. When the pneumatic valve 26 is opened by the control 16, the carrier gas carrying the abradant 32 flows through the flexible output tube 28, and the carrier gas carrying the abradant 32 is expelled out of the nozzle 30. The carrier gas carrying the abradant 32 is shown in the figures being expelled through the nozzle 30, and delivering the abradant 18 to a tooth 34.

The pneumatic valve 26 as shown in the figures is a pinch valve, and is directly attached to the vibrator 24. This attachment is a preferred embodiment according to the present invention. The pneumatic valve 26 directly attached to the vibrator 24 provides faster drilling for helium gas and non-helium gas. This beneficial effect was observed when the sole gas used to form the carrier gas for the abradant was helium gas or non-helium gas. Another benefit to this preferred embodiment is that directly attaching the pneumatic valve 26 to the vibrator 24 makes the apparatus more compact. As used herein, “directly attached,” means a range that includes “direct contact with” the vibrator 24 or “in such close proximity that the beneficial effect of faster drilling still occurs,” and contemplates proximity or closeness that is not direct, i.e. a material plate may be between so as to not be direct, and still obtains the benefit of the close attachment for faster drilling.

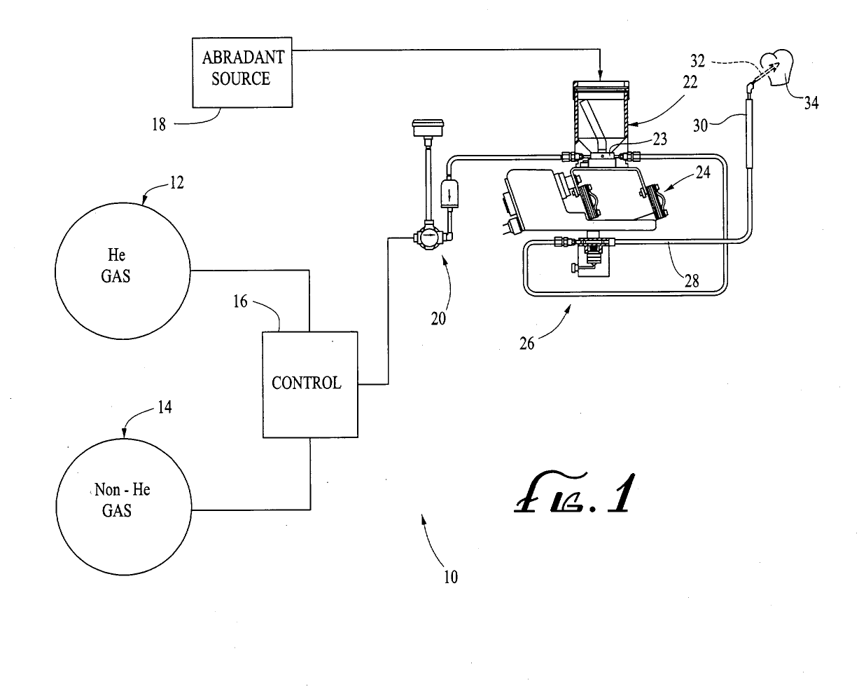

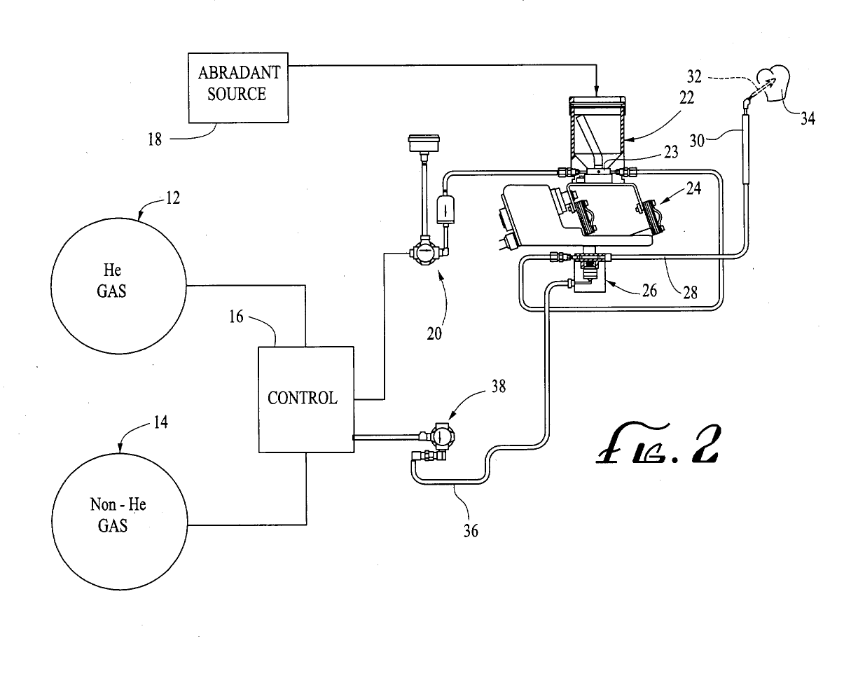

The difference between FIG. 1 and FIG. 2 is that the second preferred embodiment shown in FIG. 2 has a conduit 36 for delivering the pressurized non-helium gas to the pneumatic valve 26, and the control 16 using a pneumatic valve regulator 38 with the pneumatic valve 26 further regulates delivery of pressurized non-helium gas to operate the pneumatic valve 26. When a pneumatic system is used for the valve, FIG. 2 further enhances cost savings by having the least expensive non-helium gas, typically compressed air, carbon dioxide, or nitrogen operate the pneumatic system in the apparatus, and save the more expensive helium gas for carrier gas. For example, in the Crystal Mark DV-1 Air Abrasion Unit upgrade model and the Crystal Mark DV-2 Air Abrasion Unit (both units sold by Crystal Mark), the pneumatic valve is operated by compressed air and not helium gas. A pneumatic system to operate the valve is not mandatory to obtain the benefits of the invention, an electrical system, such as a solenoid can be used and still be effective.

The use of pressurized helium gas in the dental abrasive system of the present invention offers several benefits. The present invention offers benefits similar to the mechanical drill without the drill's side effect of increased patient discomfort. The helium carrier gas of the invention permits drilling as fast as the mechanical drill. Like the mechanical drill, the invention's use of helium carrier gas can cut through soft leathery tooth decay. A dentist reported using carrier helium gas pressures ranging from 40 PSI to 50 PSI for cutting teeth. In the past, the same dentist reported that he would have used a high speed mechanical drill for removal of the softer decay, and switched to a dental air abrasive system upon reaching the harder dentine of the tooth. The increase in speed and cutting ability of the present invention over known dental air abrasive systems is extremely useful at pressures below 80 PSI.

Known dental air abrasion systems using pressures below 80 PSI do not usually cut teeth as well as higher pressures, while the patient pain remains comparable with pressures at 100 PSI. However, unlike prior systems, one benefit of the present invention is that helium carrier gas consistently operates at 80 PSI and below to effectively cut teeth coupled with acceptable patient comfort. The invention using helium carrier gas has satisfactorily cut teeth at 25 PSI and below. An effective use of helium carrier gas of the invention with a pressure of about 10 PSI for cutting teeth has been reported to the inventor. There is typically no need to be at or above 80 PSI for most dental procedures using the helium carrier gas. However, the present invention can use helium carrier gas with pressures at or over 80 PSI, and that is contemplated by the invention.

Another benefit of the invention is time and cost saving. Dentists who used the present invention with helium carrier gas at pressures below 80 PSI reported about 35% to 40% reductions in cutting time compared against known dental air abrasive systems.

Another benefit of the dual gas system of the present invention is its versatility. A dental abrasive system using pressurized helium gas and non-helium gas source according to the present invention allows a dentist to use the same apparatus for a variety of different dental procedures. For example, when cutting a tooth, the dentist can employ the helium carrier gas at low PSIs below 80 PSI, and effectively cut the tooth even when the tooth has soft leathery decay. If during the procedure, the helium source is exhausted or the higher abrasive impact or greater speed offered by the helium carrier is not needed, the dentist can completely switch to the pressurized non-helium gas, typically compressed air, to complete the procedure.

The dentist also has the flexibility of controlling the mixture of helium in the carrier gas from none to 100%, and the concomitant amount of non-helium gas from 100% to none. For example, the dentist can form pressurized carrier gas having at least 1% by volume of the helium gas and at least 1% by volume of a non-helium gas for delivering the abradant to the teeth in dental procedures.

Another benefit is the user can chose when a helium carrier gas is necessary for a procedure. Because helium gas is more expensive than non-helium gas such as air, carbon dioxide, and nitrogen, the dentist using the present invention can use non-helium gas for procedures that do not require the benefits of the helium carrier gas. For example, in low pressure dental situations, such as polishing teeth, the dentist can use non-helium gases such as air, carbon dioxide, or nitrogen for the carrier gas, and obtain a slower less abrasive stream of gas than the carrier helium gas stream.

### EXAMPLE

The inventor has empirically demonstrated that carrier gas formed with helium gas according to the present invention cut faster than carrier gas formed with compressed air or carbon dioxide at lower PSIs of 40 PSI and 80 PSI. The inventor conducted an experiment using the following compressed gases: helium, air, and carbon dioxide in a Crystal Air DV-1 Air Abrasion unit S/N: 990686 (manufactured by Crystal Mark, 613 Justin Avenue, Glendale, Calif. 91201). Other materials used for the experiment were as follows: 8020 Final Test Center (Model No. 8020, manufactured by Crystal Mark, 613 Justin Avenue, Glendale, Calif. 91201) the Model No. 8020 operates to bypass the foot switch on the DV-1 Air Abrasion unit, and starts the DV-1 unit and a timer at the same time, and stops the timer and machine at the same time with a pressure switch requiring 5 PSI to test the units; Air Compressor; Bottle of CO2; Bottle of He; 1 mm thk. Glass Slides (Cat. No. 420 sold by Chase Scientific Glass, P.O. Box 2027, Norcross, Ga. 30091); Nozzle sapphire 0.018 or 0.46 mm; Air-Line Moisture Monitor (model AMM-15, manufactured by Ohmic Instruments, Co., 508 August Street, Easton, Md., 21601); Certified Stopwatch (model 122.0101-W0, manufactured by Hanhart, Gmbh & Co, KG, Uhrenfabrik, Hauptstabe 33, D-78148 GuttenBach, Germany, and sold in U.S. by Eric Armin, Inc. Franklin Lakes, N.J. 07417-0844) identified as CSD1; Certified Pressure gauge (manufactured by Noshok) identified as CDS2. The following procedure was used:

1. Verify all equipment used: Pin nozzle orifice (0.018); Use certified stop watch (CSD1) to verify timer on 8020 Final Test Center is accurate; Use Air-Line Moisture Monitor (Model AMM-15) to establish a temperature and dew point for each gas; Measure each slide to verify uniform thickness.

2. Use Compressed Air to establish a base line for other gasses.

3. Fill DV-1 with ½ cup of # 16W Al₂O₃ brand of aluminum oxide with an average particle size of 27.5 microns (sold by Crystal Mark, 613 Justin Avenue, Glendale, Calif. 91201)

4. Drill 12 holes at 40 PSI and at 80 PSI.

5. Record times on test data sheet.

6. Take 2 powder consumption tests at 80 PSI for 1 min. after step 4 for each gas.

7. After powder consumption test remove powder and clean abrasive pathway with air.

8. Before next gas fill DV-1 with 1/2 cup of #16W Al₂O₃.

9. Repeat step 4 through 7 for each gas.

The test results for the gases at 40 PSI and 80 PSI are shown in the following table:

| Gasses | | Air | | CO₂ | | He | |
|---|---|---|---|---|---|---|---|
| Temp. | DP. | 67.1° F. | 26.6° F. | 67.3° F. | 22.0° F. | 67.3° F. | 19.7° F. |

| 40 PSI | 10.66 | 11.24 | 10.76 | 13.06 | 12.46 | 12.60 | 7.01 | 7.03 | 7.84 |
|---|---|---|---|---|---|---|---|---|---|
| | 11.34 | 10.95 | 10.78 | 12.42 | 12.84 | 12.50 | 6.97 | 7.32 | 7.22 |
| | 11.31 | 11.13 | 11.49 | 12.16 | 13.15 | 12.51 | 6.97 | 7.36 | 7.58 |
| | 11.25 | 11.72 | 11.31 | 12.93 | 13.13 | 12.70 | 7.15 | 7.38 | 7.68 |
| Total average | 11.16 sec. | | | 12.74 sec. | | | 7.29 sec. | | |
| Mean average | 11.15 sec. | | | 12.73 sec. | | | 7.27 sec. | | |
| Slide Thickness | 1.00 mm | | | 1.00 mm | | | 1.00 mm | | |
| 80 PSI | 3.53 | 3.28 | 3.52 | 4.45 | 4.31 | 4.24 | 2.22 | 2.61 | 2.38 |
| | 3.29 | 3.43 | 3.56 | 4.45 | 4.46 | 4.46 | 2.63 | 2.75 | 2.17 |
| | 3.212 | 3.42 | 3.53 | 4.42 | 4.56 | 4.28 | 2.43 | 2.83 | 2.28 |
| | 3.20 | 3.40 | 3.45 | 4.36 | 4.26 | 4.33 | | | |

| Total average | 3.40 sec. | | 4.38 sec. | | 2.48 sec. | |
|---|---|---|---|---|---|---|
| Mean average | 3.41 sec. | | 4.38 sec. | | 2.48 sec. | |
| Slide Thickness | 1.00 mm | | 1.00 mm | | 1.00 mm | |
| Powder | 2.61 g | 2.74 g | 2.96 g | 2.86 g | 2.26 g | 1.70 g |
| consumption | | | | | | |

The following observations were made from the test results:

1. All holes drilled a nozzle tip distance of 4.40 mm with the same nozzle.

2. The diameter of the orifice created in the glass slides varies between gasses at the same pressure: Air 0.012 inches; CO₂ 0.010 inches; and He 0.015 inches.

3. The diameter of the orifice created in the glass slide varied at different pressure with the same gas. The higher the pressure the smaller the orifice.

4. The reason for the above orifice variance is the 8020 Final Test Center used a pressure switch to stop the clock. The pressure switch requires 5 PSI to trigger. The higher the pressure the faster this happens and the thinner the gas the slower this happens. Hence, this is a reason that the holes are larger at the same pressure with helium, a thinner gas.

Based on the test results shown in the table, as well as the observations discussed above, the inventor concluded that the helium carrier gas cuts even faster than the test results shown in the experiment. The test results showed that helium carrier gas with abradant cuts better than air carrier gas with abradant or carbon dioxide carrier gas with abradant at 80 PSI and lower. In that the main gas present in air is nitrogen, the results of an experiment with nitrogen would be anticipated to be similar to the two non-helium gases used in the experiment.

A variety of different permutations of the invention is contemplated, and not meant to be limited by this disclosure. The present invention is not limited to the preferred embodiments described in this section. The embodiments are merely exemplary, and one skilled in the art will recognize that many others are possible in accordance with this invention. Having now generally described the invention, the same will be more readily understood through references to the following examples, which are provide by way of illustration, and are not intended to be limiting of the present invention, unless so specified.

Having thus described the invention, it should be apparent that numerous modifications and adaptations may be resorted to without departing from the scope and fair meaning of the instant invention as set forth hereinabove and as described hereinbelow by the claims.

Although the present invention has been described in considerable detail with reference to certain preferred versions thereof, other versions are possible. Therefore, the spirit and scope of the appended claims should not be limited to the description of the preferred versions described herein.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” or “step” clause as specified in 35 U.S.C. § 112.

What is claimed is:

1. An apparatus for abrading teeth using an abradant comprising:
a) a pressurized helium gas source; and
b) a control for regulating pressurized helium gas to form a carrier gas containing helium gas for carrying the abradant to teeth.

2. The apparatus of claim 1 wherein the carrier gas formed has a pressure of below 80 PSI for carrying the abradant to the teeth.

3. The apparatus of claim 1 wherein the carrier gas formed has a pressure of about 60 PSI or below for carrying the abradant to the teeth.

4. The apparatus of claim 1 wherein the carrier gas formed has a pressure of about 50 PSI or below for carrying the abradant to the teeth.

5. The apparatus of claim 1 wherein the carrier gas formed has a pressure of about 40 PSI or below for carrying the abradant to the teeth.

6. The apparatus of claim 1 wherein the carrier gas formed has a pressure of about 30 PSI or below for carrying the abradant to the teeth.

7. The apparatus of claim 1 wherein the carrier gas formed has a pressure of about 25 PSI or below for carrying the abradant to the teeth.

8. An apparatus for abrading teeth using an abradant comprising:
a) a pressurized helium gas source;
b) a source of pressurized non-helium gas; and
c) a control capable of selectively mixing the pressurized helium and the pressurized non-helium gas to form a carrier gas for carrying the abradant to teeth, wherein the carrier gas can contain from 0-100% helium gas.

9. The apparatus of claim 8 wherein the pressurized non-helium gas is selected from the group consisting of air, carbon dioxide, and nitrogen.

10. The apparatus of claim 8 further comprising a pneumatic valve and a conduit for delivering pressurized non-helium gas to the pneumatic valve, and wherein the control is further capable of operating the pneumatic valve.

11. The apparatus of claim 10 further comprising a vibrator directly attached to the pneumatic valve.

12. An apparatus for abrading teeth using an abradant comprising:
a) a pressurized helium gas source;
b) a source of pressurized non-helium gas;
c) a conduit for delivering the pressurized non-helium gas to a pneumatic valve; and
d) a control for regulating pressurized helium gas to form a carrier gas containing helium gas for carrying the abradant to teeth, and for regulating the delivery of pressurized non-helium gas to the pneumatic valve.

13. The apparatus of claim 12 wherein the pressurized non-helium gas is selected from the group consisting of air, carbon dioxide, and nitrogen.

14. The apparatus of claim 12 wherein the carrier gas formed has a pressure of below 80 PSI for carrying the abradant to the teeth.

15. The apparatus of claim 12 wherein the carrier gas formed has a pressure of about 60 PSI or below for carrying the abradant to the teeth.

16. The apparatus of claim 12 wherein the carrier gas formed has a pressure of about 50 PSI or below for carrying the abradant to the teeth.

17. The apparatus of claim 12 wherein the carrier gas formed has a pressure of about 40 PSI or below for carrying the abradant to the teeth.

18. The apparatus of claim 12 wherein the carrier gas formed has a pressure of about 30 PSI or below for carrying the abradant to the teeth.

19. The apparatus of claim 12 wherein the carrier gas formed has a pressure of about 25 PSI or below for carrying the abradant to the teeth.

20. The apparatus of claim 12 further comprising a vibrator directly attached to the pneumatic valve.

21. An apparatus for abrading teeth using an abradant comprising:
a) a pressurized helium gas source;
b) a source of pressurized non-helium gas; and
c) a control for mixing pressurized helium gas and pressurized non-helium gas to form a carrier gas containing both gases for carrying the abradant to teeth.

22. The apparatus of claim 21 wherein the pressurized non-helium gas is selected from the group consisting of air, carbon dioxide, and nitrogen.

23. The apparatus of claim 22 further comprising a pneumatic valve and a conduit for delivering pressurized non-helium gas to the pneumatic valve, and wherein the control is further capable of operating the pneumatic valve.

24. The apparatus of claim 23 further comprising a vibrator directly attached to the pneumatic valve.

25. A method of abrading teeth comprising the steps of:
a) providing an abradant; and
b) delivering the abradant to teeth with pressurized helium carrier gas.

26. A method of abrading teeth comprising the steps of:
a) providing an abradant; and
b) delivering the abradant to teeth with pressurized helium carrier gas below 80 PSI.

27. A method of abrading teeth comprising the steps of:
a) providing an abradant; and
b) delivering the abradant with a pressurized carrier gas comprising at least 1% by volume helium and at least 1% by volume of a non-helium gas.
